(19) United States
(12) Patent Application Publication
(10) Pub. No.: US 2010/0002715 A1
(43) Pub. Date: Jan. 7, 2010

(54) THERMALLY FLEXIBLE AND PERFORMANCE SCALABLE PACKET PROCESSING CIRCUIT CARD

(75) Inventors: Dion Pike, Stittsville (CA); John Madsen, Austin, TX (US)

Correspondence Address: Kramer & Amado, P.C., 1725 Duke Street, Suite 240, Alexandria, VA, 22314, US

(73) Assignee: ALCATEL LUCENT, Paris (FR)

(21) Appl. No.: 12/168,449

(22) Filed: Jul. 7, 2008

(51) Int. Cl. H04L 12/56

(52) U.S. Cl. 370/415; 370/389

(57) ABSTRACT

Embodiments of the invention provide a packet processing circuit card with scalable performance at specified operational bandwidths over a given range of bandwidths. Advantageously, these embodiments enable a packet processing circuit card developed for a high bandwidth application to be used in a lower bandwidth application. This allows for cost-effective scaling of packet processing performance to the needs of the data communications system.

### FIELD OF THE INVENTION

The invention is directed to communication networks and in particular to data packet processing in data communications systems.

### BACKGROUND OF THE INVENTION

Data communications systems typically rely on a backplane based architecture comprising a plurality of circuit cards that plug into, or are otherwise electrically connected to, a system backplane. Examples of the type circuit cards included in data communications systems include control cards, input/output (I/O) cards, line cards, and processor cards.

Data communications systems such as switches and routers often have specially designed packet processing circuit cards for various performance requirements. However, in some cases one or more of these circuit cards may be used in a lower performance application. For example, a high bandwidth packet processing circuit card, e.g. 20 gigabit per second (Gbps) packet processing card, could be used to service a 10 Gbps input/output (I/O) circuit card. This use reduces system development costs and increases economies of scale by allowing the same card to serve multiple bandwidth applications. However, such use can fall short of meeting a number of constraints such as those relating to thermal, power supply, and radiated emissions considerations.

Thermal restrictions can render high bandwidth circuit cards un-useable in lower bandwidth applications, especially in lower cost data communication systems where cost implications are of primary concern. This is because high bandwidth circuit cards often require elegant cooling solutions due to their high power consumption, and these solutions usually require the use of high power fans and costly heat sinks. These requirements often rule out the use of such circuit cards in some data communication systems, or if used, they can significantly add to the cost of a system. Furthermore, power supply requirements of high bandwidth circuit cards often results in those circuit cards not being used in lower bandwidth applications. For example, when power required by the circuit cards can not be fully supplied by an existing power supply. As well, radiated emissions of high bandwidth circuit cards can exceed limits for low bandwidth applications. These excess emissions often restrict which data communications systems the card can be used in, or coping with them adds significant cost due to implementation of measures such as extra metal caging, filters, and so on.

Therefore, using a high bandwidth circuit card, even in a low bandwidth application where the circuit card is under-utilized, can increase the cost of a data communications system in order to properly deal with thermal, power supply, and radiated emissions constraints. Consequently, one of the main challenges in designing state of the art packet processing circuit cards is balancing performance ability with performance requirement. Unfortunately, from a system cost and design basis, addressing this challenge often results in multiple circuit cards for multiple applications.

Accordingly, there is a need to a provide packet processing circuit card that can be easily adapted for use in high bandwidth and low bandwidth applications without incurring significant costs to deal with thermal, power supply, and radiated emissions constraints.

### SUMMARY OF THE INVENTION

Embodiments of the invention provide a packet processing circuit card with scalable performance at specified operational bandwidths over a given range of bandwidths.

According to an aspect of the invention a packet processing circuit card for a data communications system is provided. The packet processing circuit card includes a packet processing module that is operable to perform packet processing operations on incoming data packets. The packet processing module includes a plurality of inputs for receiving the incoming data packets and a plurality of outputs for transmitting processed data packets. The plurality of inputs includes a first group and a second group. The packet processing circuit card also includes a traffic management module that has a plurality of inputs for receiving the processed data packets from the packet processing module and is operable to perform traffic management operations on them. The traffic management module also includes a plurality of outputs comprising first and second groups for transmitting managed traffic flows of processed data packets. The first group of the outputs is coupled to the first group of inputs of the packet processing module. The traffic management module is further operable to direct a processed data packet to one of the group of outputs, which group depends upon information contained in the processed data packet.

Advantageously, embodiments of the invention enable a packet processing circuit card developed for a high bandwidth application to be used in a lower bandwidth application. Furthermore, embodiments of the invention can be used in multiple applications to provide better economy of scale than prior art packet processing cards that are limited to one application. Still further, embodiments of the invention advantageously provide the ability to cost-effectively scale packet processing performance with the needs of the data communications system.

### BRIEF DESCRIPTION OF THE DRAWINGS

The invention will be further understood from the following detailed description with reference to the drawings, in which:

FIG. 1 is a high level functional diagram of a packet processing circuit card that is in accordance with an embodiment of the present invention; and

FIG. 2 is a table showing configuration settings for three different configurations of the packet processing circuit card of FIG. 1.

### DETAILED DESCRIPTION

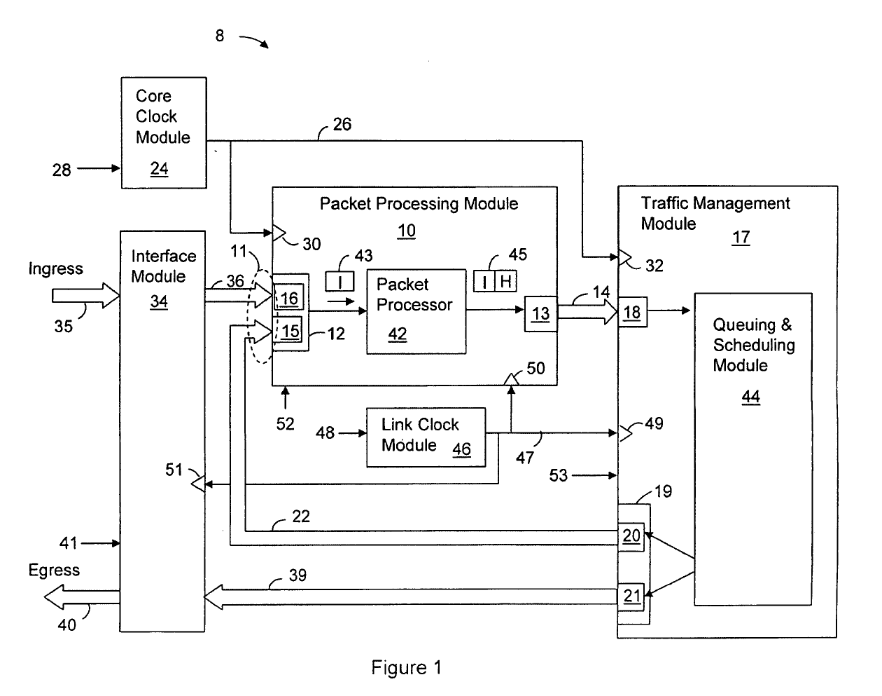

Referring to FIG. 1, a packet processing circuit card 8 for a data communications system includes a packet processing module 10 that performs packet processing operations on incoming data packets 11. The packet processing module 10 includes a plurality of inputs 12 for receiving the incoming data packets 11 and a plurality of outputs 13 for transmitting processed data packets 14. The plurality of inputs 12 includes a first group of inputs 15 and a second group of inputs 16.

The packet processing circuit card 8 also includes a traffic management module 17 that has a plurality of inputs 18 for receiving processed data packets 14 from the packet processing module 10. The traffic management module 17 also has a plurality of outputs 19 comprising a first group 20 and second group 21; the first group 20 of which are coupled to the first group of inputs 15 of the packet processing module 10. The traffic management module 17 is operable to direct a data packet to one of said group of outputs 20, 21 depending upon a header of the data packet. Data packets that are transmitted from the first group 20 of outputs are passed through the packet processing module 10 again for additional processing and are hence referred to herein as a recirculation traffic flow 22 of data packets.

The packet processing circuit card 8 further includes a core clock module 24 that is operable to output a core clock signal 26, the frequency of which depends upon a core clock configuration setting 28. The core clock configuration setting 28 would be provisioned via instructions initiated from an operator console of the data communications system or it could be provisioned via a network management system, element management system, or other system generally referred to hereinafter as an operations support system.

The packet processing module 10 and traffic management module 17 each further comprise a respective core clock input 30, 32 for receiving the core clock signal 26 and each are further operable to synchronize their respective packet processing and traffic management operations to the core clock signal 26. This synchronization does not necessarily cause the packet processing and traffic management operations to occur at exactly the same frequency of the core clock signal 26, but more generally it causes the periodicities of such operations to be equal to, or an integral multiple or fraction of, the period of the core clock signal 26. Other operations relating to a transmission rate of traffic being transmitted from the plurality of outputs 13 of the packet processing module 10 and from the plurality of outputs 19 of the traffic management module 17 are synchronized to a different clock, as will be described later.

The packet processing circuit card 8 further includes an interface module 34 that is operable to receive ingress data packets 35 and to forward them to the packet processing module 10 as an ingress traffic flow 36 of data packets.

The interface module 34 is further operable receive egress data packets 39 from the second group of outputs 21 of the traffic management module 17 and transmit them as an egress flow 40 of data packets at a egress data rate that is in accordance with a egress configuration setting 41. The egress configuration setting 41 can be provisioned in any of the aforementioned ways that the core clock configuration setting 28 can be provisioned.

The packet processing module 10 further includes a packet processor 42 that in addition to performing aforementioned packet processing operations is further operable to modify an incoming data packet 43 by attaching a header H to it depending on information I contained in the data packet 43, resulting in a modified data packet 45. The header H is used by the traffic management module 17 in the queuing and scheduling operations that it performs, as will be described shortly.

The traffic management module 17 also includes a queuing and scheduling module 44 that is operable to receive the modified data packet 45 from the plurality of inputs 18 of the traffic management module 17, and queue the modified data packet 45 for transmission from one of the group of outputs 20, 21 according to the header H. Where the modified data packet 45 is to be transmitted from the second group of outputs 21, the header H is either removed by the queuing and scheduling module 44 or by the interface module 34.

The processing circuit card 8 further includes a link clock module 46 that is operable to output a link clock signal 47, the frequency of which depends upon a link clock configuration setting 48. The link clock configuration setting 48 can be provisioned in any of the ways that aforementioned configuration settings can be provisioned. The traffic management module 17, packet processing module 10, and interface module 34 each include a respective link clock input 49, 50, and 51 for receiving the link clock signal 47 and are each operable to synchronize the rate of respective traffic flows 22 and 39, 14, and 36 transmitted from them to the link clock signal 47. This synchronization does not necessarily cause the rate of these traffic flows to exactly match the frequency of the link clock signal 47, but more generally it causes the periodicities of such rates to be equal to, or an integral multiple or fraction of, the period of the link clock signal 47.

The packet processing module 10 is provisioned with a policing configuration setting 52 to control a policing function therein that is applied to the ingress traffic flow 36. The policing configuration setting 52 can be provisioned in any of the ways that aforementioned configuration settings can be provisioned.

The traffic management module 17 is provisioned with a shaping configuration setting 53 to control a rate shaping function therein that is applied to the recirculation traffic flow 22. The shaping configuration setting 53 can be provisioned in any of the ways that aforementioned configuration settings can be provisioned.

An advantage of the packet processing circuit card 8 is that it is configurable such that packet processing bandwidth applied to the ingress traffic flow 36 and that applied to the recirculation traffic flow 22 can be selectively controlled. This is done by adjusting the policing function of the packet processing module 10 via the policing configuration setting 52 and by provisioning the packet processing module 10 to control for which information I contained in a data packet 43 a header H is to be added, which in effect controls the amount of recirculation traffic 22. This provisioning, although not shown, could be accomplished in any of the aforementioned ways in which the configuration settings can be provisioned, or it could be provisioned by software loaded into the packet processing module 10 when the data packet processing circuit card 8 is powered up. This configurability enables a tradeoff to be made between traffic flows that involve complex packet processing operations that require two or more passes for each of their data packets through the packet processing module 10 and others that require only a single pass.

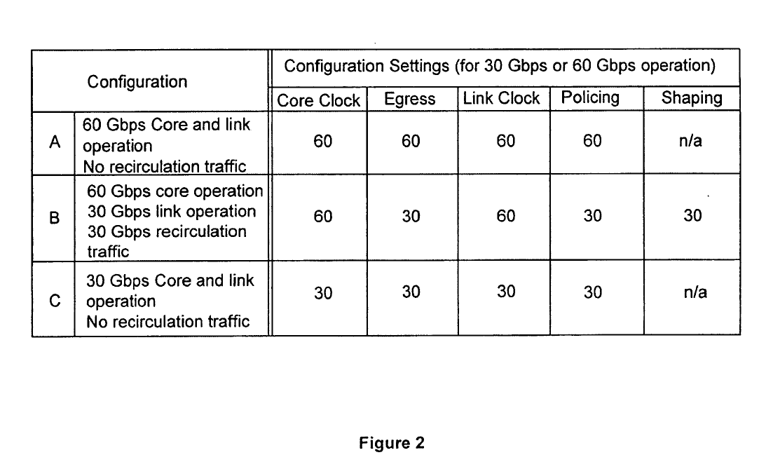

Referring to FIG. 2, in a first configuration A the packet processing module 10 and traffic management module 17 are capable of 60 Gbps performance. The packet processing circuit card 8 is provisioned to receive 60 Gbps of data packet traffic and perform a single pass operation of packet processing on it. That is, the packet processing module 10 is provisioned to disable the affixing of the aforementioned header H to data packets, which results in no recirculation traffic flow 22. In this first configuration A, the core clock module 24 and the link clock module 46 are configured for 60 Gbps operation via the core clock and link clock configuration settings 28, 48, respectively. In addition, the egress and policing configuration settings 41, 52 are also provisioned for 60 Gbps operation, while the shaping configuration setting 53 controlling rate shaping of the recirculation traffic flow 22 is not applicable because there is no such traffic.

Alternatively, in a second configuration B the packet processing circuit card 8 is provisioned to receive 30 Gbps of ingress traffic flow 36 and to perform a second pass of operation on it as recirculation traffic flow 22. That is, 30 Gbps of data packet traffic would be processed by the packet processing module 10 on a first pass and then the resulting processed traffic would be re-circulated back through the packet processing module 10 for a second pass of packet processing operations, before being transmitted from the packet processing circuit card 8 via the interface module 34. In this second configuration B, the core clock module 24 is configured for 60 Gbps operation via the core clock configuration setting 28 and the link clock module 46 is configured for 60 Gbps operation via the link clock configuration setting 48. In addition, the egress, policing, and shaping configuration settings 41, 52, 53 are provisioned for 30 Gbps operation.

In a third configuration C the packet processing circuit card 8 is provisioned to receive 30 Gbps of data packet traffic and perform a single pass operation of packet processing on it. That is, the packet processing module 10 is provisioned to disable the affixing of the aforementioned header H, which would result in no recirculation traffic flow 22. In this third configuration C, the core clock module 24 and the link clock module 46 are configured for 30 Gbps operation via the core clock and link clock configuration settings 28, 48, respectively. In addition, the egress and policing configuration settings 41, 52 are also provisioned for 30 Gbps operation, while the shaping configuration setting 53 controlling rate shaping of the recirculation traffic flow 22 is not applicable because there is no such traffic. This third configuration would be useful where only 30 Gbps of packet processing performance is required and reduced power consumption is desirable as compared to operating the packet processing card at 60 Gbps. Therefore, in cases where the full performance of the packet processing and traffic management modules 10, 17 are under-utilized, or where otherwise employing them would be too restrictive e.g. due to thermal constraints, the core and link clock signals 26, 47 are slowed down to reduce power consumption of those modules 10, 17. This is done by provisioning the core clock configuration setting 28 to adjust the core clock module 24 to provide a slower core clock signal 26 and by provisioning the link clock configuration setting 48 to provide a slower link clock signal 47.

Numerous modifications, variations and adaptations may be made to the embodiment of the invention described above without departing from the scope of the invention, which is defined in the claims.

What is claimed is:

1. A packet processing circuit card for a data communications system, comprising:
a packet processing module operable to perform packet processing operations on incoming data packets, the packet processing module comprising a plurality of inputs for receiving the incoming data packets and a plurality of outputs for transmitting processed data packets, wherein the plurality of inputs comprises a first group and a second group; and
a traffic management module having a plurality of inputs for receiving processed data packets from the packet processing module and being operable to perform traffic management operations thereon, and having a plurality of outputs comprising first and second groups for transmitting managed traffic flows of processed data packets, the first group of which outputs are coupled to said first group of inputs, and wherein the traffic management module is further operable to direct a processed data packet to one of said group of outputs in dependence upon information contained in the processed data packet.

2. The packet processing circuit card of claim 1, further comprising:
a core clock module operable to output a core clock signal in dependence upon a core clock configuration setting; and
wherein the packet processing module and traffic management module each further comprise a respective core clock input for receiving the core clock signal and each are further operable to synchronize their respective operation to the core clock signal.

3. The packet processing circuit card of claim 2, further comprising:
a link clock module operable to output a link clock signal in dependence upon a link clock configuration setting; and
wherein the packet processing module and traffic management module each further comprise a respective link clock input for receiving the link clock signal and each are further operable to synchronize to the link clock signal a rate at which processed data packets are transmitted from the modules.

4. The packet processing circuit card of claim 3, wherein:
the packet processing module further comprises a packet processor operable to modify an incoming data packet by attaching a header thereto in dependence upon information contained in the incoming data packet; and
the traffic management module further comprises a queuing and scheduling module operable to queue the incoming data packet so modified for transmission from one of said group of outputs according to said header.

5. The packet processing circuit card of claim 4, wherein the packet processing module is further operable to apply a policing function to incoming data packets received at the second group of inputs in accordance with a policing configuration setting.

6. The packet processing circuit card of claim 5, wherein the traffic management module is further operable to apply a rate shaping function to the processed data packets transmitted from the first group of outputs in accordance with a shaping configuration setting.

7. The packet processing circuit card of claim 6, wherein the interface module is further operable receive egress data packets from the traffic management module and transmit them as an egress flow of data packets at a egress data rate that is in accordance with a egress configuration setting.
